(19) United States
(12) Patent Application Publication
(10) Pub. No.: US 2016/0298664 A1
(43) Pub. Date: Oct. 13, 2016

(54) Apparatus and Method for Securing Straps or Strings of Sporting Equipment

(71) Applicant: Robert Geoffrey Benson, JR., West Chester, PA (US)

(72) Inventor: Robert Geoffrey Benson, JR., West Chester, PA (US)

(21) Appl. No.: 14/684,389

(22) Filed: Apr. 12, 2015

(51) Int. Cl. F16B 2/10; A63B 59/02; F16B 11/00

(52) U.S. Cl. CPC F16B 2/10; F16B 11/006; A63B 59/02

(57) ABSTRACT

A clasp mechanism for sporting equipment includes first and second lateral members. The second lateral member is hingably attached to the first lateral member. A first portion of the first lateral member is releasably attached to a second portion of the first lateral member and at least partially fixably attached to the second lateral member. A lumen is defined between the first and second lateral members.

### BACKGROUND OF THE INVENTION

The present invention relates generally to a clasp mechanism for strings of a netted sport device, and more particularly, to an improved, quick-snap, clasp mechanism for the strings of a lacrosse stick head, tennis racket or the like.

Traditionally the strings of lacrosse heads and tennis rackets are either; tied, knotted, taped or crimped. The problem with knotting strings is that knots can slip or become hard to untie and even harder to adjust to the proper length. Likewise the flaw with taping or crimping is that the strings cannot be easily adjusted if at all and the tape can become worn and compacted.

Thus, it would be desirable to trap the string at the proper length so it will keep the same size pocket with a clasp mechanism. Once the string is trapped in the clasp mechanism with the teeth holding it in place and the mechanism abutted to the head of the crosse (lacrosse stick head) the strings will remain in place keeping the pocket legal and at an optimum size.

It is desirable to provide a clasp mechanism that is releasably locked on the string of the head of a sporting device such that it can be easily readjusted. Further, it is preferably desirable to provide a quick release or quick snap clasp mechanism that can be releasably detached, adjusted, and reattached.

### BRIEF SUMMARY OF THE INVENTION

Briefly stated, the present invention comprises a clasp mechanism for sporting equipment. The clasp mechanism includes first and second lateral members. The second lateral member is hingably attached to the first lateral member. The first portion of the first lateral member is releasably attached to a second portion of the first lateral member and at least partially fixably attached to the second lateral member. A lumen is defined between the first and second lateral members.

### BRIEF DESCRIPTION OF THE SEVERAL VIEWS OF THE DRAWINGS

FIG. 1 Perspective view of a clasp mechanism for sporting devices in accordance with a preferred embodiment of the present invention in a closed position;

FIG. 2 Perspective view of the clasp mechanism of FIG. 1 in an open position;

FIG. 3 is a top plan view of the clasp mechanism of FIG. 1;

FIG. 4 is a cross-sectional, front elevation view of the clasp mechanism of FIG. 3 taken along lines 4;

FIG. 5 is a cross-section, front elevation view of an alternate embodiment of the clasp mechanism of FIG. 1;

FIG. 6 depicts one embodiment of the clasp mechanism of FIG. 1 affixed to the strings of a sporting device; and

FIG. 7 depicts an alternate embodiment of the clasp mechanism of FIG. 1 affixed to the strings of a sporting device,

### DETAILED DESCRIPTION OF THE INVENTION

Certain terminology is used in the following description for convenience only and should not be construed as limiting. “a” as used in the claims and in the corresponding portions of the Specification, means “one or more than one.”

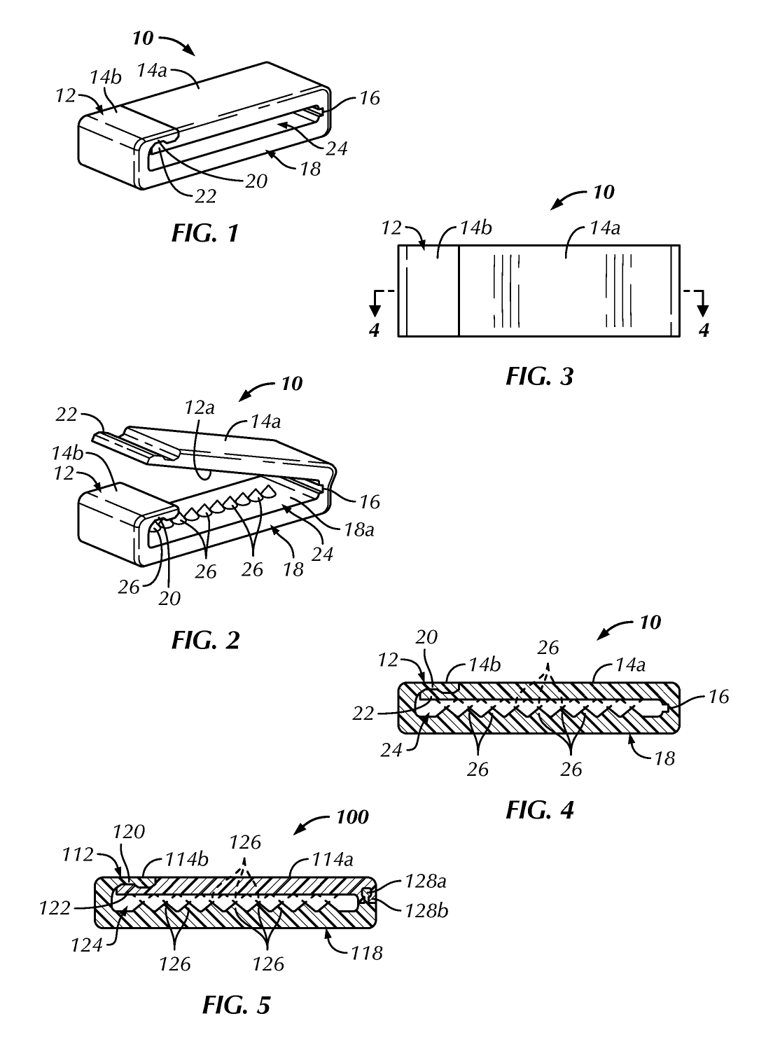

Referring to the drawings in detail, FIGS. 1-5 depict clasp mechanism 10 for sporting equipment (for example, a lacrosse stick head 30). The clasp mechanism 10 includes first and second lateral members 12, 18. The second lateral member 12 is hingably attached by hinge 16 to the first lateral member 12. A first portion 14a of the first lateral member 12 is releasably attached to a second portion 14b of the first lateral member 12 and at least partially fixably attached to the second lateral member 18. A lumen 24 is defined between the first and second lateral members 12,18.

One of the first and second portions 14a,14b of the first lateral member 12 may include an indentation 20, and the other of the first and second portions 14a,14b of the first lateral member 12 includes a protuberance 22 configured to mate with the indentation 20. The first and second portions 14a, 14b of the first lateral member 12 releasably interlock. It will be understood by one of ordinary in the art that other latch and or detent mechanisms could be utilized to interlock the first and second portions 14a, 14b of the first lateral member 12. Likewise the first lateral member 12 may also releasably connect directly or indirectly to the second lateral member 18.

The clasp mechanism 10 may be formed of metal, polymeric material and combinations of other materials such as wood, ceramic and the like. The first and second lateral members 12,18 are hingably attached by the hinge 16. Preferably the clasp mechanism 10 is formed of a unitary molded polymeric material such that the hinge 16 is integrally formed between the first and second lateral members 12, 18. However the hinge 16 can be formed as a separate device such as a metal type hinge which is connected to the first and second lateral members 12, 18.

And interior surface 12a, 18a relative to the lumen 24 of at least one of the first and second lateral members 12, 18 include a gripping device 26. The gripping device 26 may be one or more of protuberances, spikes, pins, pegs, abrasive material, tacky material, adhesive material. One of ordinary skill in the art would recognize that the gripping device 26 could be any number of different designs to firmly retain strings 35 of sporting equipment 30. Alternatively the first and second lateral member 12, 18 can be configured to be tightly secured so as to trap the strings 35 by force and or friction.

FIG. 5 demonstrates one example of how the head of a lacrosse stick can be attached to the strings 35. The clasp mechanism described herein is a unitary structure but could also be a two or more piece interlock or two piece snapping mechanism. The clasp mechanism may; snap together, latch together. The mechanism may also twist onto the lacrosse head strings like a twist plastic tie with teeth. The twist mechanism would snap or latch as the clasp mechanism does. The clasp mechanism could be developed to attach to just one of each strings so each cross would have four clasp mechanisms.

FIG. 5 is a cross-section, front elevation view of an alternate embodiment of the clasp mechanism of FIG. 1.

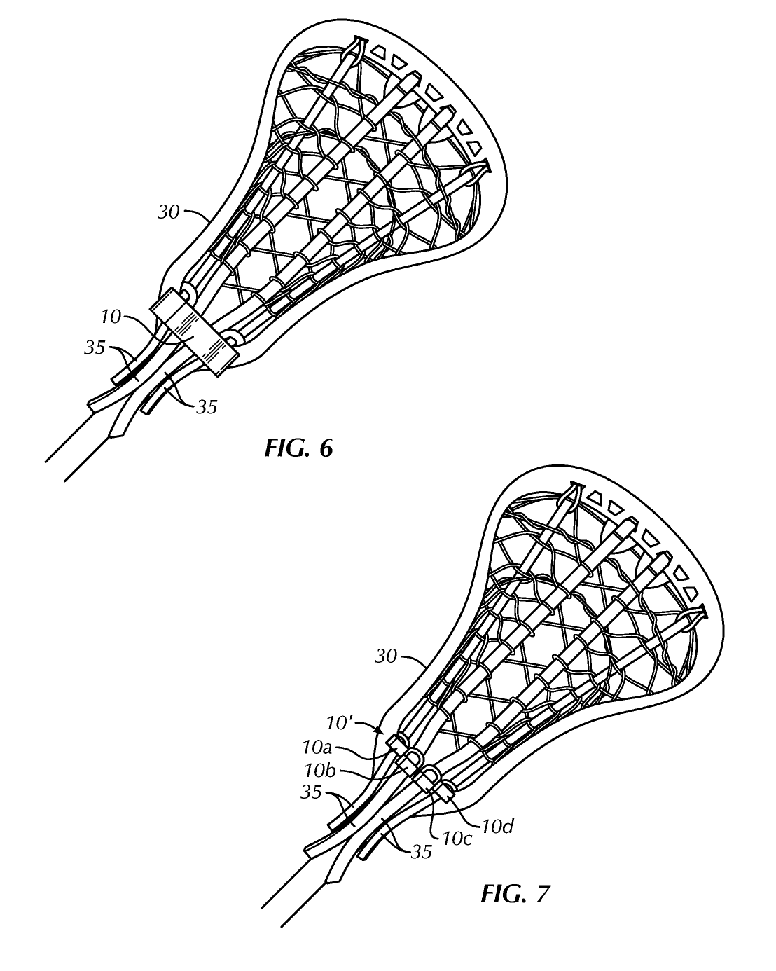

FIG. 6 depicts one embodiment of the clasp mechanism of FIG. 1 affixed to the strings of a sporting device. FIG. 7 depicts an alternate embodiment of the clasp mechanism of FIG. 1 affixed to the strings of a sporting device,

From the forgoing, it can be seen that the present invention comprises a clasp mechanism for securing strings of sporting equipment. It will be appreciated by those skilled in the art that changes could be made to the embodiments described above without departing from the broad inventive concept thereof. It is understood therefore, that this invention is not limited to the particular embodiments disclosed, but it is intended to cover modifications within the spirit and scope of the present invention as defined by the appended claims.

I claim:

1. A clasp mechanism for sporting equipment, comprising:
a first lateral member;
a second lateral member hingably attached to the first lateral member;
a first portion of the first lateral member being releasably attached to a second portion of the first lateral member and at least partially fixably attached to the second lateral member; and
a lumen being defined between the first and second lateral members.

2. The clasp mechanism of claim 1 wherein one of the first and second portions of the first lateral member includes an indentation and the other of the first and second portions of the first lateral member includes a protuberance configured to mate with the indentation

3. The clasp mechanism of claim 1 wherein the first and second portions of the first lateral member releasably interlock.

4. The clasp mechanism of claim 1, wherein an interior surface relative to the lumen of at least one of the first and second lateral members includes at least one of protuberances, spikes, pins, pegs, abrasive material, tacky material, adhesive material.

5. The clasp mechanism of claim 1, wherein the clasp mechanism is formed of one of metal, polymeric material, wood, ceramic or combinations thereof.

6. The clasp mechanism of claim 1, wherein the clasp mechanism is formed as a unitary structure.

7. The clasp mechanism of claim 1, wherein the clasp mechanism is a multi-piece structure.

8. The clasp mechanism of claim 1, wherein the hinge is integrally formed with the first and second lateral members.

9. The clasp mechanism of claim 1, wherein the hinge is attached to the first and second lateral members.
